(19) United States
(12) Patent Application Publication
(10) Pub. No.: US 2014/0284923 A1
(43) Pub. Date: Sep. 25, 2014

(54) PIPE COUPLING

(71) Applicant: Yung-Yu CHANG, Tainan City (TW)

(72) Inventor: Yung-Yu CHANG, Tainan City (TW)

(21) Appl. No.: 13/947,487

(22) Filed: Jul. 22, 2013

(30) Foreign Application Priority Data
Mar. 20, 2013 (TW) 102109828

(51) Int. Cl. F16L 33/04

(52) U.S. Cl. CPC F16L 33/04
USPC 285/420

(57) ABSTRACT

A pipe coupling has a lashing ring, a fastening screw and a gap shield. The lashing ring is mounted around a junction where two pipes are telescoped together. The fastening screw fastens two ends of the lashing ring. The gap shield is mounted on an inner surface of the lashing ring and covers a gap defined between the two ends of the lashing ring. With the gap shield covering the gap, when a fluid with high pressure flows through the pipes, the pipes do not deform at a part corresponding to the gap. Consequently, the fluid does not leak from the gap.

### BACKGROUND OF THE INVENTION

1. Field of the Invention

The present invention relates to a pipe coupling, especially to a pipe coupling that is securely mounted around a junction where two pipes are telescoped together to prevent the pipes from leaking fluid.

2. Description of the Prior Art(s)

With reference to FIG. 4, a conventional pipe coupling is securely mounted around a junction where a first pipe 4 and a second pipe 5 are telescoped together to prevent the first pipe 4 and the second pipe 5 from leaking fluid. The conventional pipe coupling comprises a lashing ring 6 and a fastening screw 7. The lashing ring 6 has a ring portion 60, an alignment fin 63 and an alignment recess 64. The ring portion 60 has an inner surface, a first connecting end 61, a second connecting end 62, and an opening 601. The opening 601 is defined between the first connecting end 61 and the second connecting end 62. The alignment fin 63 protrudes from the first connecting end 61, is disposed adjacent to the inner surface of the ring portion 60, and has a distal edge. The alignment recess 64 is formed in the second connecting end 62 and through the inner surface of the ring portion 60 and receives the alignment fin 63. An inner sidewall is defined in the alignment recess 64 and corresponds to the distal edge of the alignment fin 63. The fastening screw 7 is mounted through and is fastened to the first connecting end 61 and the second connecting end 62 of the ring portion 60, such that the lashing ring 6 can be securely mounted around the junction where the first pipe 4 and the second pipe 5 are telescoped together.

With the alignment fin 63 protruding in the alignment recess 64, the inner surface of the ring portion 60 along with the alignment fin 63 can securely wrap around the first pipe 4 and the second pipe 5. However, normally, an inner diameter of the ring portion 60 is smaller than an outer diameter of the junction where the first pipe 4 and the second pipe 5 are telescoped together, such that a gap 65 exists between the distal edge of the alignment fin 63 and the inner sidewall defined in the alignment recess 64. Thus, assume that the first pipe 4 is mounted outside the second pipe 5 and is made of resilient rubber, when a fluid with high pressure flows through the first pipe 4 and the second pipe 5, the fluid with high pressure may force the first pipe 4 to deform at a part corresponding to the gap 65, which causes the fluid to leak.

To overcome the shortcomings, the present invention provides a pipe coupling to mitigate or obviate the aforementioned problems.

### SUMMARY OF THE INVENTION

The main objective of the present invention is to provide a pipe coupling. The pipe coupling has a lashing ring, a fastening screw and a gap shield. The lashing ring has a ring portion, a first connecting portion, a second connecting portion, an alignment fin and an alignment recess. The ring portion is mounted around a junction where two pipes are telescoped together and has an opening defined between two ends of the ring portion. The first connecting portion and the second connecting portion are respectively formed on the two ends of the ring portion. The alignment fin transversely protrudes from the first connecting portion. The alignment recess is transversely formed in the second connecting portion and receives the alignment fin. The fastening screw fastens the first connecting portion and the second connecting portion. The gap shield is detachably mounted on an inner surface of the ring portion and covers a gap defined between a distal edge of the alignment fin and an inner sidewall defined in the alignment recess.

With the gap shield covering the gap, when a fluid with high pressure flows through the pipes, the pipes do not deform at a part corresponding to the gap. Accordingly, the fluid does not leak from the gap.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a pipe coupling in accordance with the present invention;

FIG. 2 is a perspective view of the pipe coupling in FIG. 1;

FIG. 3 is an operational and cross-sectional top view of the pipe coupling in FIG. 1; and

FIG. 4 is an operational and cross-sectional top view of a conventional pipe coupling in accordance with the prior art.

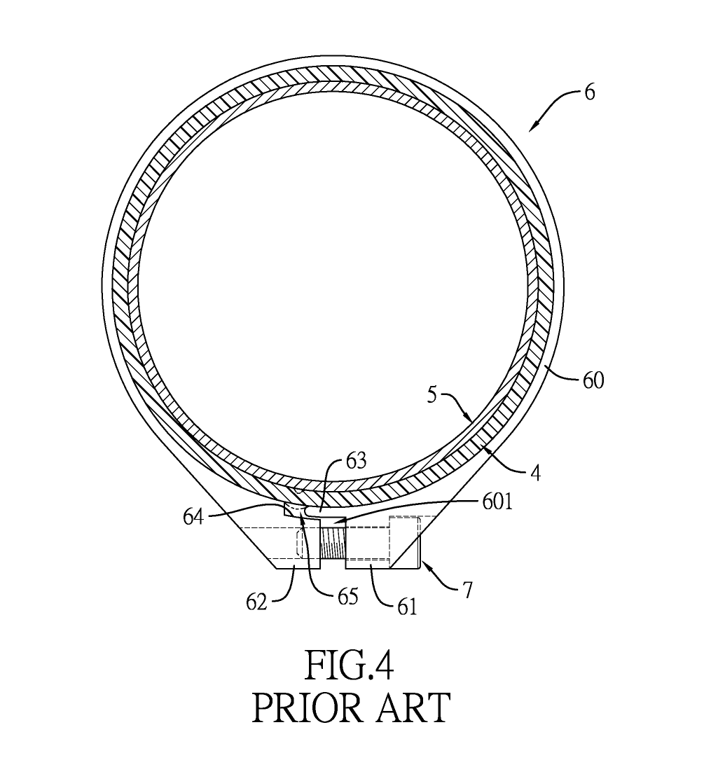

### DETAILED DESCRIPTION OF THE PREFERRED EMBODIMENTS

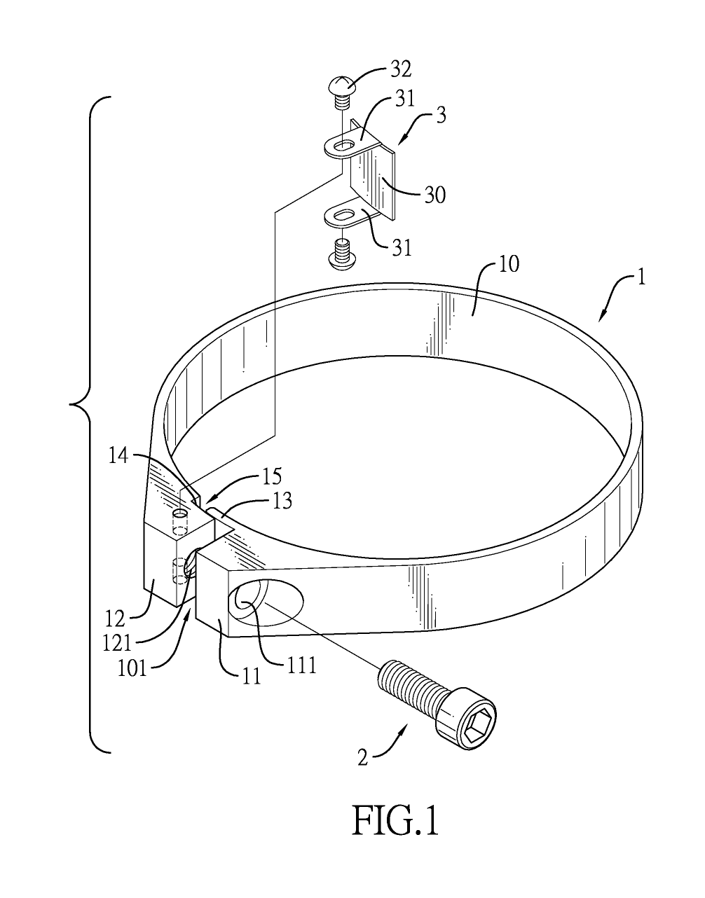

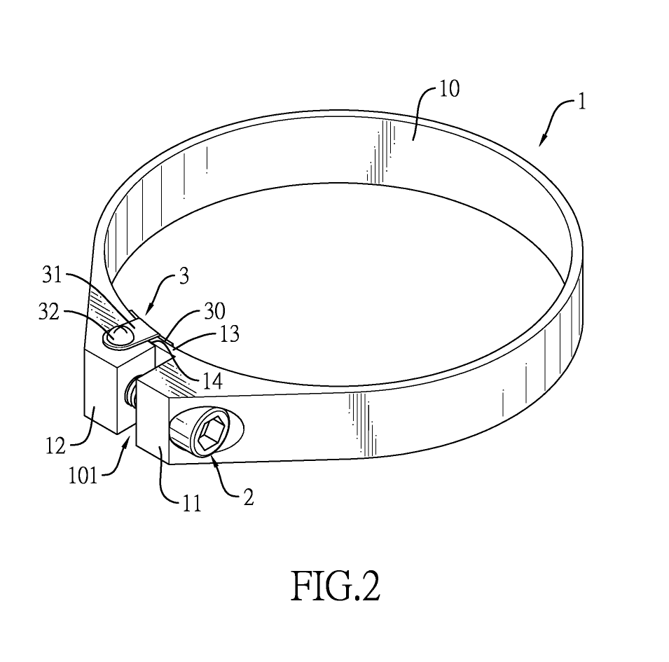

With reference to FIGS. 1 and 2, a pipe coupling in accordance with the present invention comprises a lashing ring 1, a fastening screw 2 and a gap shield 3.

With reference to FIG. 1, the lashing ring 1 has an upper peripheral surface, a lower peripheral surface, a ring portion 10, a first connecting portion 11, a second connecting portion 12, an alignment fin 13, an alignment recess 14 and an inner sidewall. The ring portion 10 has an inner surface, two ends, and an opening 101. The opening 101 is formed between the two ends of the ring portion 10 such that the ring portion 10 is extendable. The first connecting portion 11 is formed on one of the two ends of the ring portion 10 and has an end surface and a through hole 111. The through hole 111 of the first connecting portion 11 is transversely formed through the first connecting portion 11. The second connecting portion 12 is formed on the other end of the ring portion 10 and has an end surface and a threaded hole 121. The threaded hole 121 of the second connecting portion 12 is transversely formed through the second connecting portion and aligns with the through hole 111 of the first connecting portion 11. The alignment fin 13 transversely protrudes from the end surface of the first connecting portion 11, is disposed adjacent to the inner surface of the ring portion 10, and has a distal edge. The alignment recess 14 is formed in the end surface of the second connecting portion 12 and through the inner surface of the ring portion 10, and receives the alignment fin 13. The inner sidewall of the ring portion 10 of the lashing ring 1 is defined in the alignment recess 14 and corresponds to the distal edge of the alignment fin 13.

With reference to FIGS. 1 to 3, the fastening screw 2 fastens the first connecting portion 11 and the second connecting portion 12 of the ring portion 10 of the lashing ring 1. Specifically, the fastening screw 2 is mounted through the through hole 111 of the first connecting portion 11 and engages the threaded hole 121 of the second connecting portion 12.

Alternatively, the through hole 111 may be formed through the second connecting portion 12 and the threaded hole 121 may be formed through the first connecting portion 11. Thus, the fastening screw 2 is mounted through the through hole 111 of the second connecting portion 12 and engages the threaded hole 121 of the first connecting portion 11 to fasten the first connecting portion 11 and the second connecting portion 12.

With reference to FIGS. 1 to 3, the gap shield 3 is detachably mounted on the inner surface of the ring portion 10 and covers the distal edge of the alignment fin 13 and the inner sidewall defined in the alignment recess 14. Consequently, a gap 15 defined between the distal edge of the alignment fin 13 and the inner sidewall defined in the alignment recess 14 is covered by the gap shield 3. The gap shield 3 may be made of metal or plastic and has a hard panel 30, two positioning wings 31 and two fasteners 32. The hard panel 30 is mounted on the inner surface of the ring portion 10, and corresponds to the distal edge of the alignment fin 13 and the inner sidewall defined in the alignment recess 14, such that the hard panel covers the gap 15 defined between the distal edge of the alignment fin 13 and the inner sidewall defined in the alignment recess 14 to separate the gap 15 from a space surrounded by the inner surface of the ring portion 10. The hard panel 30 has an upper edge and a lower edge. A thickness of the hard panel 30 of the gap shield is 0.4 millimeter (mm) to 0.8 mm. The positioning wings 31 respectively protrude transversely from the upper edge and the lower edge of the hard panel 30, and are respectively mounted on the upper peripheral surface and the lower peripheral surface of the lashing ring 1. Each positioning wing 31 has a mounting hole formed through the positioning wing 31. The fasteners 32 may be screws or rivets, are respectively mounted through the mounting holes of the positioning wings 31, and fasten the lashing ring 1. Specifically, the fasteners 32 fasten the second connecting portion 12 of the ring portion 10.

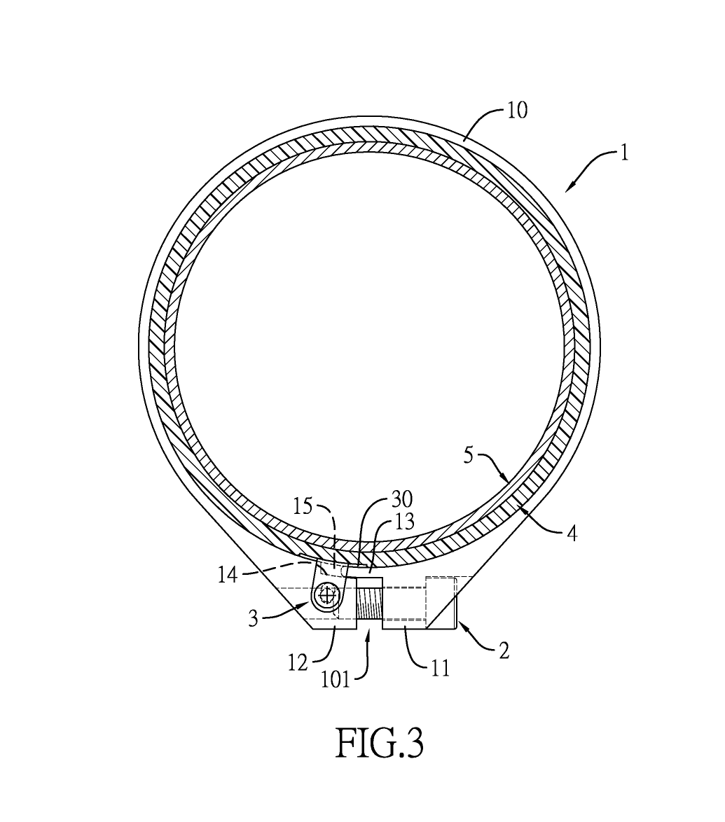

The pipe coupling as described has the following advantages. With reference to FIG. 3, assume that a first pipe 4 is made of resilient rubber, and a second pipe 5 is made of hard materials, such as metal or plastic, and protrudes into the first pipe 4. The ring portion 10 of the lashing ring 1 of the pipe coupling is mounted around the junction where the first pipe 4 and the second pipe 5 are telescoped together. The fastening screw 2 fastens the first connecting portion 11 and the second connecting portion 12 of the lashing ring 1 to reduce a radius of the ring portion 10 and to allow the ring portion 10 to be securely mounted around the first pipe 4 and the second pipe 5. Thus, with the gap shield 3 covering the gap 15 defined between the distal edge of the alignment fin 13 and the inner sidewall defined in the alignment recess 14, when a fluid with high pressure flows through the first pipe 4 and the second pipe 5, the first pipe 4 and the second pipe 5 do not deform at a part corresponding to the gap 15. Accordingly, the fluid does not leak from the gap 15.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pipe coupling comprising:
a lashing ring having
a ring portion having
an inner surface;
two ends; and
an opening defined between the two ends of the ring portion;
a first connecting portion formed on one of the two ends of the ring portion and having an end surface;
a second connecting portion formed on the other end of the ring portion and having an end surface;
an alignment fin protruding from the end surface of the first connecting portion and having a distal edge;
an alignment recess formed in the end surface of the second connecting portion and through the inner surface of the ring portion, and receiving the alignment fin; and
an inner sidewall defined in the alignment recess and corresponding to the distal edge of the alignment fin;
a fastening screw fastening the first connecting portion and the second connecting portion; and
a gap shield detachably mounted on the inner surface of the ring portion and covering the distal edge of the alignment fin and the inner sidewall defined in the alignment recess.

2. The pipe coupling as claimed in claim 1, wherein
the first connecting portion further has a through hole transversely formed through the first connecting portion;
the second connecting portion further has a threaded hole transversely formed through the second connecting portion and aligning with the through hole of the first connecting portion; and
the fastening screw is mounted through the through hole of the first connecting portion and engages the threaded hole of the second connecting portion.

3. The pipe coupling as claimed in claim 1, wherein
the lashing ring has an upper peripheral surface and a lower peripheral surface;
the gap shield has
a hard panel mounted on the inner surface of the ring portion, covering the distal edge of the alignment fin and the inner sidewall defined in the alignment recess, and having an upper edge and a lower edge;
two positioning wings respectively protruding transversely from the upper edge and the lower edge of the hard panel, and respectively mounted on the upper peripheral surface and the lower peripheral surface of the lashing ring, and each positioning wing having a mounting hole formed through the positioning wing; and
two fasteners respectively mounted through the mounting holes of the positioning wings, and fastening the lashing ring.

4. The pipe coupling as claimed in claim 2, wherein
the lashing ring has an upper peripheral surface and a lower peripheral surface;
the gap shield has
a hard panel mounted on the inner surface of the ring portion, covering the distal edge of the alignment fin and the inner sidewall defined in the alignment recess, and having an upper edge and a lower edge;
two positioning wings respectively protruding transversely from the upper edge and the lower edge of the hard panel, and respectively mounted on the upper peripheral surface and the lower peripheral surface of the lashing ring, and each positioning wing having a mounting hole formed through the positioning wing; and
two fasteners respectively mounted through the mounting holes of the positioning wings, and fastening the lashing ring.

5. The pipe coupling as claimed in claim 3, wherein the fasteners of the gap shield are screws and engage the second connecting portion of the ring portion.

6. The pipe coupling as claimed in claim 4, wherein the fasteners of the gap shield are screws and engage the second connecting portion of the ring portion.

7. The pipe coupling as claimed in claim 3, wherein a thickness of the hard panel of the gap shield is 0.4 millimeter (mm) to 0.8 mm.

8. The pipe coupling as claimed in claim 4, wherein a thickness of the hard panel of the gap shield is 0.4 mm to 0.8 mm.

9. The pipe coupling as claimed in claim 5, wherein a thickness of the hard panel of the gap shield is 0.4 mm to 0.8 mm.

10. The pipe coupling as claimed in claim 6, wherein a thickness of the hard panel of the gap shield is 0.4 mm to 0.8 mm.
